(19) United States
(12) Patent Application Publication
(10) Pub. No.: US 2009/0148814 A1
(43) Pub. Date: Jun. 11, 2009

(54) Dentition modeling

(76) Inventors: Chunhua Li, Cupertino, CA (US); Ken Wu, San Francisco, CA (US); Philip Ho, Mountain View, CA (US); Eric Kuo, Foster City, CA (US)

Correspondence Address: ALIGN TECHNOLOGY C/O WAGNER BLECHER LLP, 123 WESTRIDGE DRIVE, WATSONVILLE, CA, 95076, US

(21) Appl. No.: 12/001,248

(22) Filed: Dec. 10, 2007

(51) Int. Cl. A61C 13/34; C09K 3/00

(52) U.S. Cl. 433/213; 106/35

(57) ABSTRACT

A dentition model material is comprised of a gypsum composition and an additive, wherein, in response to being scanned, a dentition model produced from the dentition model material is configured to produce a signature associated with the additive.

### FIELD

Embodiments of the present technology relate in general to the field of dentition modeling.

### BACKGROUND

Dentition impressions are often taken from orthodontic patients as part of a process for producing custom orthodontic appliances, such as aligners for realigning teeth. For instance, an impression may be taken of the patient's dentition and then shipped to a facility which performs a Computed Tomography (CT) scan upon the impression. The CT scan of the impression allows a computer model to be made of the dentition, and from this computer model one or more appliances may be produced for the patient. An alternative to submitting an impression is to submit a solid stone model cast from the aforementioned impression. The gypsum dentition model may then be shipped to the appliance maker without concern for environmentally induced shape changes which may occur during shipment of an impression.

Presently, there are five International Standards Organization classifications or “types” of gypsum product under ISO 6873:1998; they are referred to as Type 1, Type 2, Type 3, Type 4, and Type 5. Any of these types of gypsum product may be used to cast a model from a dentition impression. Moreover, any of these types of gypsum product can produce dentition models that are visually very similar, if not indistinguishable from one another, to the human eye. However, not all gypsum models are created equal, as each of these types of gypsum product has particular properties with respect to strength and expansion characteristics.

For example, dentition models cast from Type 1 and Type 2 gypsum product (commonly called dental plaster) lack the strength to consistently endure the jostles which may be encountered during shipping. Dentition models cast from Type 3 and Type 5 gypsum product (commonly called dental stone) have high enough strength to routinely survive shipping; however, Type 3 and Type 5 gypsum also produce models which have high or very high properties of expansion. These properties of expansion render dentition models cast from Type 3 and Type 5 gypsum dental stone unsuitable for use in production of appliances such as custom-fit aligners. Fortunately, a dentition model cast from Type 4 gypsum product (also commonly called dental stone) has high strength coupled with low expansion. Thus, in a process where a practitioner casts a dentition model and then ships it to a manufacturer to have a dental appliance custom produced for a patient, the use of a Type 4 gypsum dental stone ensures the most consistent results and greatest patient satisfaction with the appliances produced.

However, if a practitioner is unaware of the benefit of using a Type 4 gypsum product to produce a dentition model, he may use another gypsum product. Additionally, a practitioner may intentionally use another type of gypsum product (other than Type 4), for example, because it is readily at hand or because it is less expensive than a Type 4 gypsum product. As Type 4 gypsum dentition models and non-Type 4 gypsum dentition models can be visually very similar, if not indistinguishable, an appliance manufacturer cannot easily tell if Type 4 gypsum was used to make a particular dentition model. Difficulties in distinguishing acceptable (Type 4) dentition models from unacceptable (non-Type 4) dentition models create quality control issues and additional work for the appliance manufacturer, and may result in patient dissatisfaction due to appliance fit issues. Such dissatisfaction can damage brand reputation and decrease the profits of an appliance manufacturer.

### SUMMARY

Dentition modeling is described herein. A dentition model material is comprised of a gypsum composition and an additive, wherein, in response to being scanned, a dentition model produced from the dentition model material is configured to produce a signature associated with the additive.

### BRIEF DESCRIPTION OF THE DRAWINGS

The accompanying drawings, which are incorporated in and form a part of this specification, illustrate embodiments of the dentition modeling subject matter and, together with the description, serve to explain principles discussed below.

FIG. 1 illustrates a gypsum composition and activator, in accordance with one embodiment.

FIG. 2 illustrates a perspective view of an example gypsum-based dentition model, in accordance with an embodiment.

FIG. 3 illustrates a side profile view of the example gypsum-based dentition model and example radiographs of a detail portion thereof, in accordance with various embodiments.

FIG. 4 is a flow diagram of a method for making a dentition model, in accordance with one embodiment.

FIG. 5 is a flow diagram of a method for enhancing patient satisfaction with an orthodontic product by ensuring adherence to a dentition model making protocol, in accordance with one embodiment.

FIG. 6 illustrates a mechanism for scanning a dentition model, in accordance with an embodiment.

The drawings referred to in this description should be understood as not being drawn to scale unless specifically noted.

### DESCRIPTION OF EMBODIMENTS

In the following description, numerous specific details are set forth in order to provide a thorough understanding. However, it will be recognized by one of ordinary skill in the art that embodiments may be practiced without these specific details. In other instances, well known methods, procedures, and components have not been described in detail as not to unnecessarily obscure aspects of the present technology.

### Overview

Embodiments described herein provide dentition model materials and methods of making dentition models which comply with expansion criteria and structural strength criteria and are thus of suitable quality for use as a basis for making dental appliances, for example, aligners customized for the treatment of a patient. Additionally, embodiments described herein allow for the differentiation between dentition models which possess suitable qualities of expansion criteria and structural strength criteria, and other dentition models which do not or may not posses these suitable qualities. With respect to the examples provided herein, it is appreciated that signature/identifying additives which are described do not alter the distinctive properties of the gypsum materials such that they become unsuitable for modeling purposes for which they are designed.

It is appreciated that, in one embodiment, the materials described herein are used for producing Type 4 gypsum stone dentition models that are readily identifiable as gypsum-based dentition models which possess the high strength characteristics and low expansion characteristics of dentition models cast from Type 4 gypsum material. As will be described, patient satisfaction with an orthodontic product, such as an aligner, is enhanced by ensuring compliance with a dentition model making protocol which specifies casting a dentition model from a gypsum composition which has characteristics of high strength and low expansion. Although, examples provided herein are directed to incorporating signature additives and identifying features into Type 4 gypsum material and/or dentition models made of type 4 Gypsum material, it is appreciated that the concepts and techniques described herein are generally applicable to any type of gypsum material and/or models produced there from. Thus, a person of ordinary skill in the arts described herein should be able to use the methods, signature additives, and techniques described herein with any type of gypsum material without changing the properties of the respective gypsum material.

### Materials

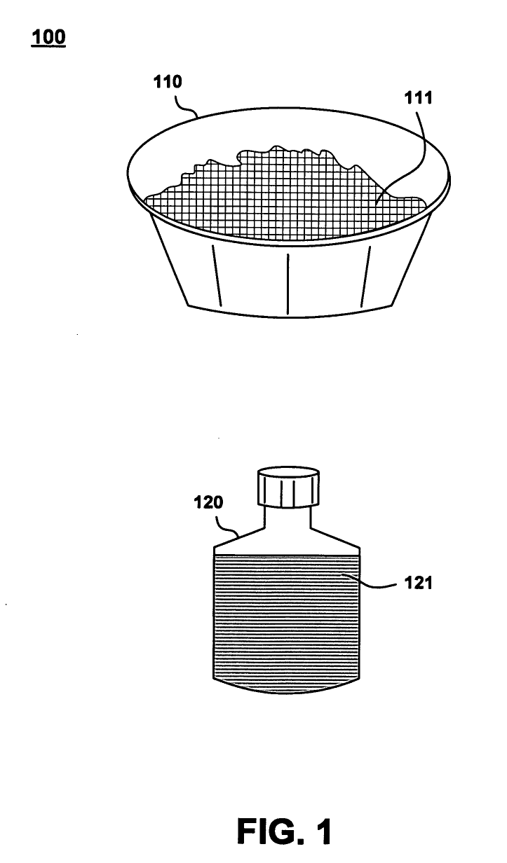

FIG. 1 illustrates a gypsum composition 111 and liquid activator 121 in accordance with one embodiment. Gypsum composition 111 is shown packaged in container 110. Liquid activator 121 is shown packaged in container 120. In one embodiment, gypsum composition 111 may be packaged in container 110 in a pre-measured amount which is suitable for mixing with a pre-measured amount of liquid activator 121 packaged in container 120. Upon mixing, the pre-measured amount of gypsum composition 111 and liquid activator 121 form a modeling material suitable for use in casting a dentition model from a dentition impression, such as an alginate dentition impression.

In one embodiment, container 110 of pre-measured gypsum composition 111 and container 120 of pre-measured liquid activator 121 are bundled together in a kit 100. The materials 111 and 121 of kit 100 may be mixed together to create a dentition modeling material useable for casting a dentition model from a dentition impression. It is appreciated that in some embodiments other items may be included in kit 100. Some examples of these other items can include, but are not limited to: a dental impression tray; a pre-measured amount of an alginate; a pre-measured amount of liquid for mixing with an alginate; an impression material such as an alginate, polyether, or polyvinylsiloxane impression material; identifiable packaging material such as a wrapper, envelope slipcover, box, or bag for packaging a completed gypsum-based dentition model; and dentition model making protocol instructions for use of the components of kit 100 to make a dentition model which will possess qualities of strength and expansion that allow the dentition model to be acceptable for use in production of an orthodontic product (e.g., an aligner) for a patient.

It is appreciated that identifiable packaging material included with kit 100 may be marked with a trademarked logo, serial number (such as a serial number associated with a particular kit 100), hologram, barcode, computer readable code, or other visible indicia, thus allowing visible identification of a dentition model which is packaged in identifiable packaging material supplied with kit 100. It is appreciated that identifiable packaging material may include an identification mechanism such as an RFID chip which is readable by an RFID scanning device, thus allowing identification, via RFID scanning, of a dentition model which is packaged in identifiable packaging material supplied with kit 100.

Gypsum composition 111 is a model material used in making dentition models and possesses high strength characteristics and low expansion characteristics suitable for use in casting dentition models from which dental appliances, such as custom fit aligners, will be produced for patient use. In one embodiment, gypsum composition 111 is suitable for producing a gypsum dentition model that is dimensionally stable to within 100 microns of the model's originally cast dimensions. In one embodiment, gypsum composition 111 is an International Standards Organization (ISO) Type 4 gypsum product commonly known as dental stone, or else complies with the standards for Type 4 gypsum product which are outlined by ISO 6873:1998.

In various embodiments, gypsum composition 111 also includes one or more additives which facilitate identification of a dentition model cast from the model material of gypsum composition 111 and thus possessing the strength and expansion criteria associated with a dentition model cast from gypsum composition 111. For example, gypsum composition 111 might include an additive such that, in response to scanning, a dentition model produced from the model material of gypsum composition 111 produces a signature associated with the additive. One example of such an additive includes a radiopaque additive which will produce a radiopaque signature in a radiograph in response to the dentition model being scanned during an X-ray scan or Computed Tomography (CT) scan. Another example of such an additive includes a radio-frequency identification (RFID) chip which will emit a unique pre-determined response when the dentition model is scanned by an RFID scanner.

It is appreciated that in some embodiments, gypsum composition 111 may be combined with other additives such as a color additive (e.g., a blue dye) which will impart a particular color (such as blue) to a dentition model cast from the model material of gypsum composition 111 and/or a fragrance additive (e.g., banana fragrance) which will impart a scent (such as banana scent) to a dentition model cast from the model material of gypsum composition 111.

Liquid activator 121 is also a model material used in making dentition models. In one embodiment, liquid activator 121 is comprised of water or substantially comprised of water. Liquid activator 121 may also be comprised of water which includes one or more other additives. In some embodiments, liquid activator 121 includes one or more additives which will facilitate identification of a dentition model cast from a modeling material made from a kit comprised of gypsum composition 111 and liquid activator 121, and thus possessing the strength and expansion criteria associated with a model made from gypsum composition 111. For example, in one embodiment liquid activator 121 includes an additive such that, in response to scanning, a dentition model produced from kit 100 produces a signature associated with the additive. One example of such an additive includes a radiopaque additive which will produce a radiopaque signature in radiograph in response to the dentition model being scanned during an X-ray scan or CT scan.

It is appreciated that liquid activator 121 may be combined with other additives such as a color additive (e.g., a blue dye) which will impart a particular color (such as blue) to a dentition model cast from the model materials of kit 100 and/or a fragrance additive (e.g., banana fragrance) which will impart a scent (such as banana scent) to a dentition model cast from the model materials of kit 100.

A radiopaque additive included in gypsum composition 111 and/or in liquid activator 121 can comprise barium sulfate, bismuth trioxide, tungsten or other suitable radiopaque material which will cause a dentition model containing the additive to exhibit a unique radiopacity associated with the radiopaque additive. This unique radiopacity will not be present in a radiograph of a dentition model that does not contain the additive, but will be visible in a radiograph (such as from an X-ray scan or CT scan) of a dentition model which contains the radiopaque additive.

Additionally, a radiopaque additive included in gypsum composition 111 and/or liquid activator 121 can comprise an x-ray identifiable macro additive. Such an x-ray identifiable macro additive causes a dentition model containing the macro additive to exhibit a unique radiopacity associated with the x-ray identifiable macro additive. Some examples of such an x-ray identifiable macro additive include: a ribbon, sphere, square, or other readily identifiable shape. Such an x-ray identifiable macro additive may be made of metal such as stainless steel, gold foil, or anther metal or material with radiopaque properties. The unique radiopacity associated with the x-ray identifiable macro additive will not be present in a radiograph of a dentition model that does not contain the macro additive, but will be visible in a radiograph (such as from an X-ray scan or CT scan) of a dentition model which contains the macro additive.

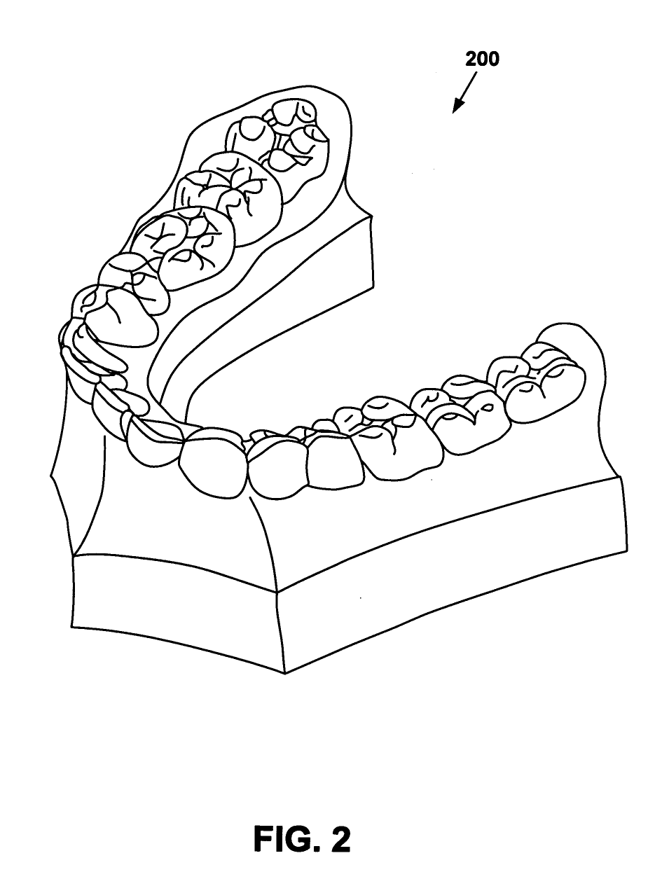

FIG. 2 illustrates a perspective view of an example gypsum-based dentition model 200 in accordance with an embodiment. For purposes of example, it may be presumed that gypsum-based dentition model 200 is comprised of Type 4 gypsum product which has been cast from a mixture of gypsum composition 111 and liquid activator 121. Also for purposes of example, it may be presumed that one or both of gypsum composition 111 and liquid activator 121 comprised one or more additives for facilitating identification of a dentition model cast from a gypsum composition possessing qualities of a Type 4 gypsum-based dentition model, such as strength criteria and expansion criteria associated with a Type 4 gypsum-based dentition model.

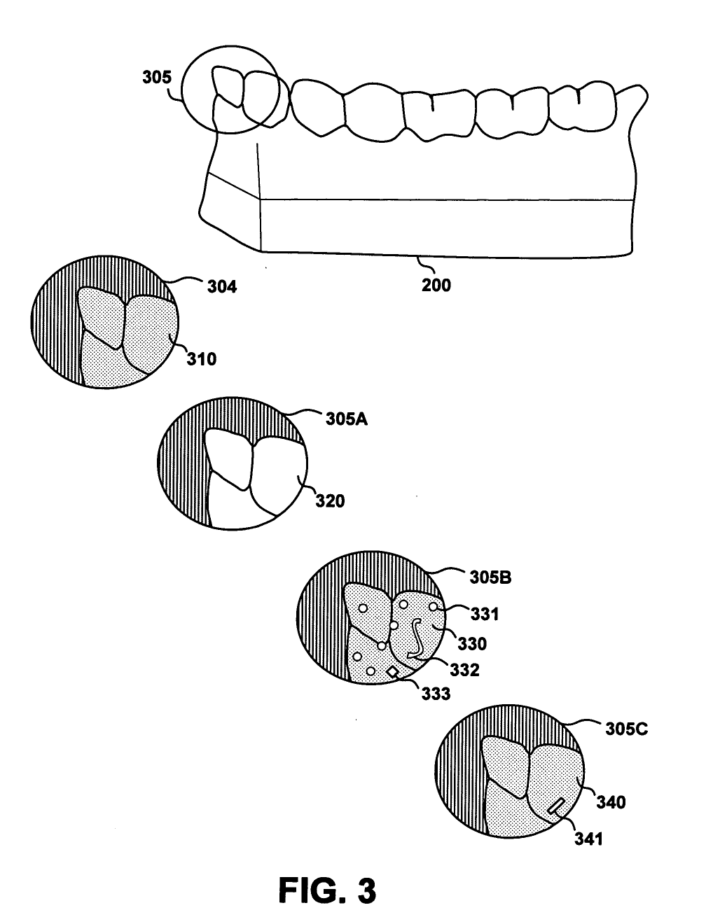

FIG. 3 illustrates a side profile view of gypsum-based dentition model 200 and example radiographs (305A, 305B, 305C) of a detail portion 305 thereof, in accordance with various embodiments. Detail 304 is shown for comparative purposes and represents a radiograph of a portion of a typical gypsum-based dentition model which is outwardly identical to gypsum-based dentition model 200, but which does not contain any sort of radiopaque additive or other identifying additive which enables ready identification of a dentition model that has been cast from gypsum composition 111 and thus possesses qualities of strength and expansion acceptable for use in production of an orthodontic product (e.g., an aligner) for a patient. As can be seen by the dark shade of region 310, a typical gypsum-based dentition model is visible in a radiograph but does not exhibit a large amount of radiopacity, or “whiteness” in the radiograph of detail 304.

In FIG. 3, detail 305A represents a radiograph of detail 305 of gypsum-based dentition model 200. In this particular embodiment, gypsum-based dentition model 200 comprises a radiopaque additive, such as barium sulfate, which has caused region 320 to have a different visual appearance in comparison to region 310 of detail 304, e.g., region 320 appears brighter than region 310. As shown in detail 305A, the radiopaque additive generates a radiopaque signature discernable via human or machine recognition in a radiograph of gypsum-based dentition model 200. This discernable difference in radiopacity is a signature associated with the radiopaque additive and serves as an indicator that gypsum-based dentition model 200 has been cast from a gypsum composition possessing the strength and expansion criteria associated with a model made from gypsum composition 111.

In FIG. 3, detail 305B represents a radiograph of detail 305 of gypsum-based dentition model 200. In this particular embodiment, gypsum-based dentition model 200 comprises several types of radiopaque macro additives in the form of an x-ray identifiable macro material. For example, with reference to region 330, a circular shaped macro additive has caused radiopaque shape 331, a ribbon shaped macro additive has caused radiopaque shape 332, and a square shaped macro additive has caused radiopaque shape 333. As shown in detail 305B, an X-ray identifiable macro additive generates a particular shape or non-uniform distribution that is discernable via human or machine recognition in a radiograph of gypsum-based dentition model 200. These discernable differences in radiopacity (e.g., shapes 331, 332, and 333) between detail 305B and detail 304 are signatures associated with radiopaque X-ray identifiable macro additives and serve as indicators that gypsum-based dentition model 200 has been cast from a gypsum composition possessing the strength and expansion criteria associated with a model made from gypsum composition 111. It is appreciated that a single shape or a plurality of different shapes of x-ray identifiable macro additives may be utilized as a radiopaque additive. It is also appreciated that an X-ray identifiable macro additive can be used in combination with a radiopaque additive similar to the type demonstrated in detail 305A.

In FIG. 3, detail 305C represents a radiograph of detail 305 of gypsum-based dentition model 200. In this particular embodiment, gypsum-based dentition model 200 comprises an RFID chip additive which is visible as shape 341 in region 340. In this example, the RFID chip is at least partially radiopaque. This difference in radiopacity is a signature associated with this particular RFID chip additive, and serves as an indicator that gypsum-based dentition model 200 has been cast from a gypsum composition possessing the strength and expansion criteria associated with a model made from gypsum composition 111. It is appreciated that the RFID chip additive responsible for shape 341 will also emit a particular pre-determined radio signature when scanned with an RFID scanner, and that this radio signature also serves as an indicator that gypsum-based dentition model 200 has been cast from a gypsum composition possessing the strength and expansion criteria associated with a model made from gypsum composition 111. It is also appreciated that an RFID chip (either radiopaque or non-radiopaque) may be utilized with combinations of radiopaque additives similar to those described in conjunction with details 305A and 305B.

Moreover, it is appreciated that one or a combination of radiopaque additives and RFID chip additives may also be utilized in combination with a color and or fragrance additive such gypsum-based dentition model 200 also comprises a pre-determined color (such as the color blue) and/or a pre-determined scent (such as banana scent) indicative that gypsum-based dentition model 200 has been cast from a gypsum composition possessing the strength and expansion criteria associated with a model made from gypsum composition 111.

### Method for Making a Dentition Model

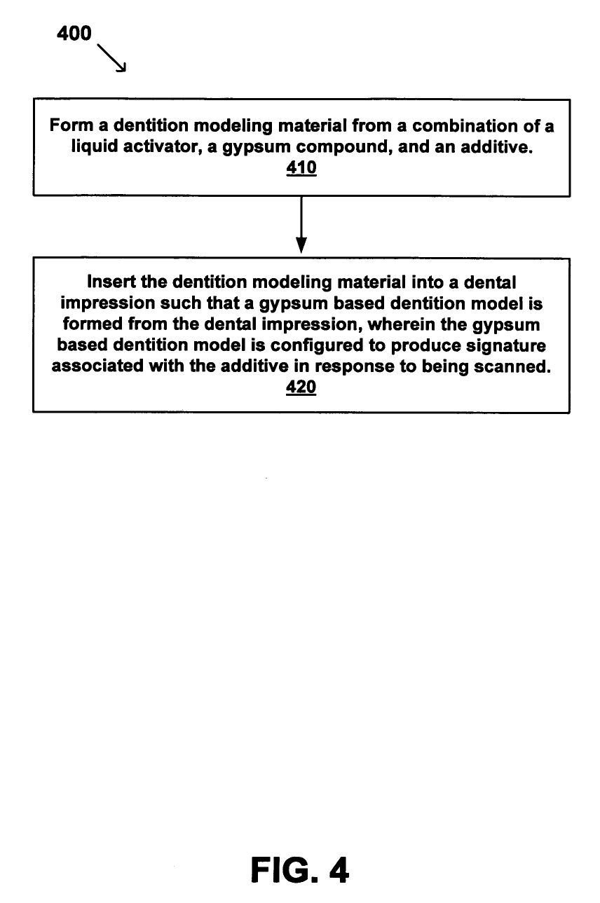

FIG. 4 is a flow diagram 400 of a method for making a gypsum-based dentition model which comprises an additive associated with a particular quality of gypsum composition model material (such as gypsum composition 111) and which may be identified, such as via scanning, within the dentition model so that quality (e.g., strength and expansion criteria) of the gypsum composition in the gypsum-based dentition model may be non-destructively confirmed.

At block 410, a dentition modeling material is formed from a combination of a liquid activator, a gypsum composition, and an additive. With reference to FIG. 1, a dentition modeling material is formed by mixing gypsum composition 111 and liquid activator 121, at least one of which contains an additive that allows a scan of a resultant gypsum-based dentition model to produce a signature associated with the additive. In one embodiment, the gypsum composition utilized is a Type 4 gypsum product, which is supplied, for example, as gypsum composition 111 of kit 100.

In one embodiment the additive comprises a radiopaque additive which is included in one or both of the liquid activator and the gypsum composition. In some embodiments, the radiopaque additive is comprised of barium sulfate, bismuth trioxide, tungsten, or other radiopaque material, such that a radiopaque signature discernable via human or machine recognition is generated in a radiograph of the gypsum-based dentition model. In some embodiments, the radiopaque additive is an x-ray identifiable macro object, which generates a particular shape or non-uniform distribution that is discernable either by a human or via machine recognition in a radiograph of the gypsum-based dentition model.

In one embodiment, the additive comprises at least one RFID chip included in the liquid activator and/or in the gypsum composition. The RFID chip may be radiopaque, partially radiopaque, or non-radiopaque. The RFID chip produces a unique pre-determined radio signature when a gypsum-based dentition model containing the RFID chip is scanned by an RFID scanner.

At block 420, the dentition modeling material is inserted into a dental impression such that a gypsum-based dentition model is formed from the dental impression. The resultant gypsum-based dentition model is configured, due to presence of the additive, to produce signature associated with the additive in response to being scanned. In one embodiment, the dentition modeling material is inserted into a dental impression, such as an alginate impression, which has been taken from the dentition of an orthodontic patient. With reference to FIG. 2 and FIG. 3, dentition model 200 represents an example of a completed gypsum-based dentition model formed according to flow diagram 400. In one instance, an instruction of a dentition model making protocol included with a kit for making a dentition model, such as kit 100, may instruct that the completed gypsum-based dentition model is to be packaged into identifiable packaging material that is included with the kit.

### Method for Enhancing Patient Satisfaction with an Orthodontic Product

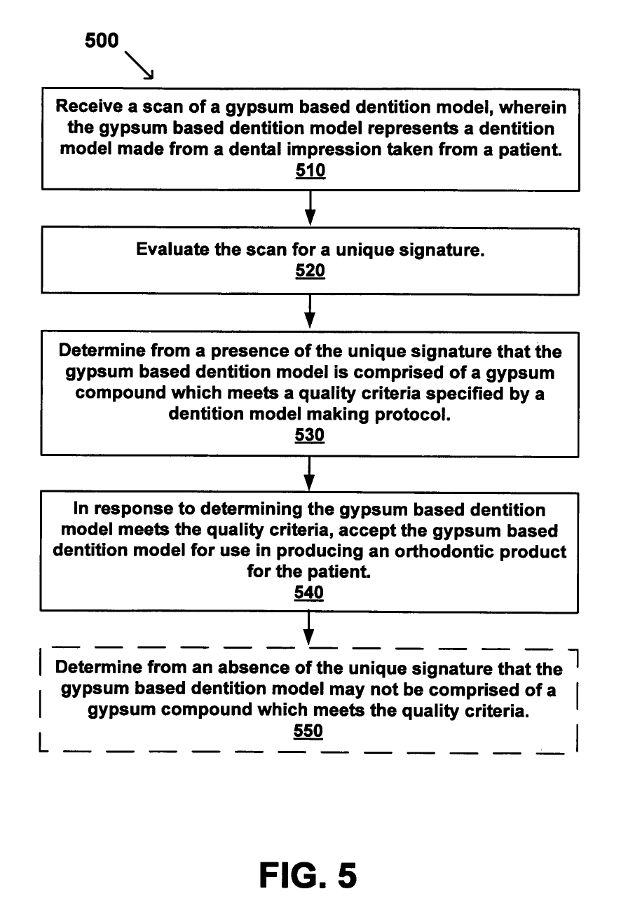

FIG. 5 is a flow diagram 500 of a method for enhancing patient satisfaction with an orthodontic product by ensuring adherence to a dentition model making protocol that requires use of a gypsum material with certain qualities. For example, one such protocol specifies that a detention model for use in making an orthodontic product be cast from a gypsum composition compiling with strength and expansion criteria associated with a Type 4 gypsum product. The present embodiment can be used to ensure that a gypsum-based dentition model complies with such a protocol and is therefore comprised of a gypsum composition which has suitable qualities, such as strength and expansion criteria, for making a dentition model from which a well fitted (not too loose or too tight) orthodontic product, such as an aligner, may be produced for patient use. Moreover, the present embodiment ensures that a gypsum-based dentition model is comprised of a gypsum composition, such as a Type 4 gypsum product, which best ensures that the gypsum-based dentition model represents an intact and dimensionally accurate model of the patient's dentition from which a well fitted orthodontic appliance can be produced. Through such measures, the present method enhances patient satisfaction with the orthodontic product by increasing the consistency with which a well fitted product is provided to a patient.

At block 510, in one embodiment, a scan of a gypsum-based dentition model is received. The gypsum-based dentition model represents a dentition model made from a dental impression taken from a patient. This can comprise receiving an RFID scan (e.g., a scan accomplished with an RFID scanner) of the gypsum-based dentition model. This can also comprise receiving a radiographic scan (e.g., a radiographic scan such as an X-ray scan or CT scan) of the gypsum-based dentition model. This scan may be performed at a facility which processes gypsum-based dentition models received from dental and/or orthodontic practitioners. The results of this scan may then be utilized as a decision point in the manufacturing of appliances based upon the gypsum-based dentition models or computer models derived from the gypsum-based dentition models. It is appreciated that such a scan may also be performed in a practitioner's office. Thus, a scan of the dentition model may be received from the practitioner, such as via physical or electronic forwarding of the scan from the practitioner to a pre-designated facility.

Prior to receiving the scan at block 510, the packaging material of a dentition model may be scanned by a human or a machine. This can comprise a visual scan of the packaging material and/or other type of scan, such as an RFID scan of the packaging material. If it is determined that the dentition model is packaged in identifiable packaging material supplied as part of a dentition model making kit, such as kit 100, then processing according to the method of flow diagram 500 is performed. If it is determined that the dentition model is not packaged in identifiable packaging material supplied as part of a dentition modeling kit, such as kit 100, then the dentition model may be rejected without further processing by the method described in flow diagram 500.

At block 520, the scan is evaluated for a unique signature. This can comprise evaluating an image (e.g., a radiograph) from a radiographic scan for a radiopaque signature associated with a radiopaque additive that has been supplied in a kit for making a gypsum-based dentition model of a quality which complies with the quality criteria. This can also comprise evaluating the result of a radio-frequency identification scan for a radio-frequency identification signature associated with a radio-frequency identification chip additive that has been supplied in a kit for making a gypsum-based dentition model of a quality which complies with the quality criteria. Such evaluation can be performed by a human or by a machine, such as a computer system coupled to a scanning device.

At block 530, from a presence of the unique signature it is determined that that gypsum-based dentition model is comprised of a gypsum composition which meets a quality criteria specified by a dentition model making protocol. Such determination can be performed by a human or by a machine, such as a computer system coupled to a scanning device.

In one embodiment, this comprises determining from a presence of a radiopaque signature that a gypsum-based dentition model is comprised of a gypsum composition which meets a strength criteria and an expansion criteria specified by the dentition model making protocol. For example, with reference to FIG. 3, such a determination can be from a presence of a unique radiopacity such as the unique brightness of region 320, or the radiopaque signature (331, 332, 333) caused by presence of an X-ray identifiable macro additive.

In one embodiment, block 530 of flow diagram 500 comprises determining from a presence of a radio-frequency identification signature that the gypsum-based dentition model is comprised of a gypsum composition which meets a strength criteria and an expansion criteria specified by the dentition model making protocol.

At block 540, in response to determining the gypsum-based dentition model meets the quality criteria, the gypsum-based dentition model is accepted for use in producing an orthodontic product for the patient. Such acceptance can be noted or performed by a human or by a machine, such as a computer system coupled to a scanning device. After the acceptance, for example, a computer model may be made from the gypsum-based dentition model. The computer model may then be utilized to create one or more orthodontic appliances, such as, for example, one or more aligners for the patient.

At block 550, if there is no unique signature found by a scan of the gypsum-based dentition model, it is determined from an absence of the unique signature that the gypsum-based dentition model may not be comprised of a gypsum composition which meets the quality criteria. Such determination can be performed by a human or by a machine, such as a computer system coupled to a scanning device. In one instance, in response to determining the gypsum-based dentition model may not meet the quality criteria, the gypsum-based dentition model is rejected for use in producing the orthodontic product for the patient. Such rejection can be noted or performed by a human or by a machine, such as a computer system coupled to a scanning device. In another instance, the absence of the unique signature triggers an additional analysis, such as a visual inspection for defects or damage or else human or machine inspection for other signifiers such as a unique smell or color that is associated with a gypsum-based dentition model made from a kit of ingredients which contains a gypsum material known to meet quality criteria of the dentition model making protocol.

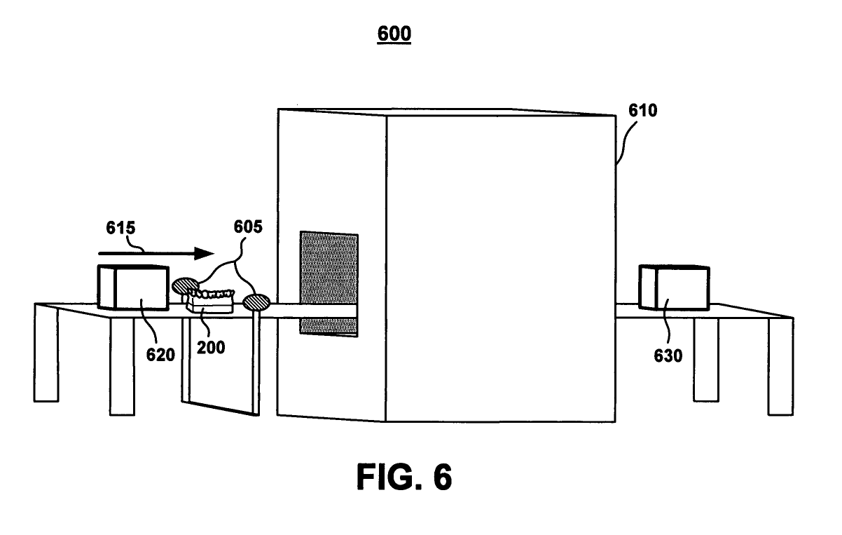

FIG. 6 illustrates an example mechanism 600 for scanning a dentition model in accordance with an embodiment. It is appreciated that the components of mechanism 600 may be arranged differently than shown, and that in some embodiments not all components shown may be utilized. Mechanism 600 comprises a radiographic scanner 610 (which may be an X-ray or CT scanner). Mechanism 600 may also include an RFID scanner 605. Although RFID scanner 605 is depicted as a fixed device, it is appreciated that RFID scanner 605 may comprise a handheld RFID scanner. As shown, a gypsum-based dentition model 200 enters mechanism 600 in direction 615 and receives an RFID scan from RFID scanner 605 and/or a radiographic scan from radiographic scanner 610. Boxes 620 and 630 represent gypsum-based dentition models which are packaged and have not been opened. Box 630 has already been scanned, while box 620 has yet to be scanned.

As can be seen, mechanism 600 allows scanning of packaged or unpackaged gypsum-based dentition models. Utilizing the method illustrated by flow diagram 500, mechanism 600 allows gypsum-based dentition models to be scanned and evaluated for compliance with a dentition model making protocol, such as a protocol specifying the use of an acceptable quality of gypsum composition. Moreover, such scanning and evaluation may be performed without unpackaging the dentition models. This results in less human involvement and speeds throughput. Additionally, in one embodiment where a scanned gypsum-based dentition model has been deemed acceptable in response to a unique signature found in an initial scan (such as a scanning by an RFID scanner), radiographic scanner 610 automatically performs a CT scan of the gypsum-based dentition model so that a computer model may be developed of the gypsum-based dentition model. This computer model is a computerized model of a patient's dentition and can be used in producing an appliance, such as an aligner, for the patient.

Although, examples provided herein are directed to incorporating identifiable additives and features into Type 4 gypsum material and/or dentition models made of type 4 Gypsum material, it is appreciated that the concepts and techniques described herein are generally applicable to any type of gypsum material and/or models. Moreover, it is appreciated that the concepts and technology described herein apply widely to a variety of modeling materials, dental alginate products, plastics, and rubbers which, for reasons similar to those described above, need to be identifiable as meeting a certain quality, grade, specification, or protocol. For example, an RFID chip, radiopaque additive, color additive, or fragrance additive can be added to one more components of a dental alginate kit or raw materials used for taking a dentition impression. This can be done to easily identify the type of material used, or the protocol followed in taking an impression. Likewise, in the manner described herein a radiopaque additive can be incorporated in a variety of raw materials which are produced into parts, such as plastic parts, in order to easily and positively identify the authenticity, quality, material use in the part, or protocol followed in making the part.

Embodiments of the dentition modeling subject matter have been described herein. While this subject matter is described in conjunction with various embodiments, it is understood that they are not intended to limit the subject matter described herein to these embodiments. On the contrary, the described subject matter is intended to cover alternatives, modifications and equivalents, which may be included within the spirit and scope of as defined by the appended claims.

What is claimed:

1. A dentition model material comprising:
a gypsum composition; and
an additive, wherein a dentition model produced from said dentition model material is configured to produce a signature associated with said additive in response to being scanned.

2. The dentition model material of claim 1, wherein said gypsum composition comprises:
a Type 4 gypsum product.

3. The dentition model material of claim 1, further comprising:
a color additive.

4. The dentition model material of claim 1, further comprising:
a fragrance additive.

5. The dentition model material of claim 1, wherein said additive comprises:
a radio-frequency identification chip.

6. The dentition model material of claim 1, wherein said additive comprises:
a radiopaque additive.

7. The dentition model material of claim 6, wherein said radiopaque additive is included in said gypsum composition.

8. The dentition model material of claim 6, wherein said radiopaque additive is included as a component of a liquid activator, said liquid activator for mixing with said gypsum composition.

9. The dentition model material of claim 6, wherein said radiopaque additive is selected from the group of radiopaque additives consisting of: barium sulfate, bismuth trioxide, tungsten, and an x-ray identifiable macro material.

10. A dentition modeling kit comprising:
a Type 4 gypsum product;
a liquid activator for mixing with said Type 4 gypsum product; and
an radiopaque additive, wherein a dentition model produced from said dentition model kit is configured to produce a radiographic signature associated with said additive in response to being radiographically scanned.

11. The dentition modeling kit of claim 10, further comprising:
identifiable packaging material for use in packaging a completed gypsum-based dentition model.

12. The dentition modeling kit of claim 10, wherein said radiopaque additive is included in said Type 4 gypsum product.

13. The dentition modeling kit of claim 10, wherein said radiopaque additive is included in said liquid activator.

14. A method for making a dentition model, said method comprising:
forming a dentition modeling material from a combination of a liquid activator, a gypsum composition, and an additive; and
inserting said dentition modeling material into a dental impression such that a gypsum-based dentition model is formed from said dental impression, wherein said gypsum-based dentition model is configured to produce signature associated with said additive in response to being scanned.

15. The method as recited in claim 14, wherein said forming a dentition modeling material from a combination of a liquid activator, a gypsum composition, and an additive comprises:
forming said dentition modeling material using a Type 4 gypsum product as said gypsum composition.

16. The method as recited in claim 14, wherein said forming a dentition modeling material from a combination of a liquid activator, a gypsum composition, and an additive comprises:
forming said dentition modeling material using at least one radio-frequency identification chip as said additive.

17. The method as recited in claim 14, wherein said forming a dentition modeling material from a combination of a liquid activator, a gypsum composition, and an additive comprises:
forming said dentition modeling material utilizing a radiopaque additive as said additive, said radiopaque additive selected from the group of radiopaque additives consisting of: barium sulfate, bismuth trioxide, tungsten, and an x-ray identifiable macro object.

18. A method for enhancing patient satisfaction with an orthodontic product by ensuring adherence to a dentition model making protocol, said method comprising:
receiving a scan of a gypsum-based dentition model, wherein said gypsum-based dentition model represents a dentition model made from a dental impression taken from a patient;
evaluating said scan for a unique signature;
determining from a presence of said unique signature that said gypsum-based dentition model is comprised of a gypsum composition which meets a quality criteria specified by a dentition model making protocol; and
in response to determining said gypsum-based dentition model meets said quality criteria, accepting said gypsum-based dentition model for use in producing an orthodontic product for said patient.

19. The method as recited in claim 18, further comprising:
determining from an absence of said unique signature that said gypsum-based dentition model may not be comprised of a gypsum composition which meets said quality criteria; and
in response to determining said gypsum-based dentition model may not meet said quality criteria, rejecting said gypsum-based dentition model for use in producing said orthodontic product for said patient.

20. The method as recited in claim 18, wherein said receiving a scan of a gypsum-based dentition model comprises:
receiving a radio-frequency identification scan of said gypsum-based dentition model.

21. The method as recited in claim 18, wherein said receiving a scan of a gypsum-based dentition model comprises:
receiving a radiograph of said gypsum-based dentition model.

22. The method as recited in claim 18, wherein said evaluating said scan for a unique signature comprises:
evaluating a radiograph for a radiopaque signature associated with a radiopaque additive supplied in a kit for making a gypsum-based dentition model of a quality which complies with said quality criteria.

23. The method as recited in claim 18, wherein said determining from a presence of said unique signature that said gypsum-based dentition model is comprised of a gypsum composition which meets a quality criteria specified by said dentition model making protocol comprises:
determining from a presence of a radiopaque signature that said gypsum-based dentition model is comprised of a gypsum composition which meets a strength criteria and an expansion criteria specified by said dentition model making protocol.

24. The method as recited in claim 18, wherein said evaluating said scan for a unique signature comprises:
evaluating a radio-frequency identification scan for a radio-frequency identification signature associated with a radio-frequency identification chip additive supplied in a kit for making a gypsum-based dentition model of a quality which complies with said quality criteria.

25. The method as recited in claim 18, wherein said determining from a presence of said unique signature that said gypsum-based dentition model is comprised of a gypsum composition which meets a quality criteria specified by said dentition model making protocol comprises:
determining from a presence of a radio-frequency identification signature that said gypsum-based dentition model is comprised of a gypsum composition which meets a strength criteria and an expansion criteria specified by said dentition model making protocol.
